(19) United States
(12) Patent Application Publication
(10) Pub. No.: US 2025/0074242 A1
(43) Pub. Date: Mar. 6, 2025

(54) ADD-ON MOBILITY APPARATUS AND CONTROL METHOD THEREOF

(71) Applicants: HYUNDAI MOTOR COMPANY, SEOUL (KR); KIA CORPORATION, SEOUL (KR)

(72) Inventor: Min Su Kim, Hwaseong-si (KR)

(73) Assignees: HYUNDAI MOTOR COMPANY, SEOUL (KR); KIA CORPORATION, SEOUL (KR)

(21) Appl. No.: 18/797,071

(22) Filed: Aug. 7, 2024

(30) Foreign Application Priority Data
Sep. 4, 2023 (KR) 10-2023-0116938

(51) Int. Cl. B60L 53/62; B60L 50/60; B60L 53/57; B60L 58/12

(52) U.S. Cl. CPC B60L 53/62; B60L 50/60; B60L 53/57; B60L 58/12; B60L 2210/10; B60L 2240/423

(57) ABSTRACT

An add-on mobility apparatus, which is configured to be driven by being connected to a front mobility apparatus including a first high-voltage battery supplying power to at least one first drive motor and a first connection mechanism, includes a second high-voltage battery supplying driving power to at least one second drive motor and charging power to the first high-voltage battery through a DC/DC converter, a second connection mechanism mechanically connected to the first connection mechanism, and a controller including a processor configured to determine the driving power and the charging power based on a first SOC of the first high-voltage battery and a second SOC of the second high-voltage battery.

### CROSS REFERENCE TO RELATED APPLICATIONS

This application claims the benefit of Korean Patent Application No. 10-2023-0116938, filed on Sep. 4, 2023, which is hereby incorporated by reference as if fully set forth herein.

### BACKGROUND

### Technical Field

The present disclosure relates to an add-on mobility apparatus and a method of controlling the same.

### Discussion of Related Art

An electric vehicle is generally driven by a driving force of a drive motor.

Also, a high-voltage battery is usually fixedly mounted on the vehicle to supply power to the drive motor.

The drive motor may be an alternating current (AC) motor and may thus include an inverter between the battery and the drive motor.

When the battery of the electric vehicle requires charging according to its state of charge, i.e., SOC, it may be charged by receiving external power through an on-board charger (OBC).

In this case, a charging time may be determined based on a charging method, which is broadly divided into slow charging and fast charging.

A travel range (or distance) per charging has been improved greatly in recent years by the continuously ongoing research and development on batteries.

However, a battery fixedly provided in an electric vehicle may not suffice, and there is accordingly a need for an alternative thereto.

### SUMMARY

The present disclosure provides solutions to the foregoing problems arising from typical technologies.

An object of the present disclosure is to provide a new concept of technology that uses a second high-voltage battery that is added to and separated from a power system of an electric vehicle as needed, in addition to a first high-voltage battery already installed in the electric vehicle.

An object of the present disclosure is also to provide a control method, for an add-on mobility apparatus that includes a second high-voltage battery and is driven on its own, which may improve the efficiency based on a state of charge (SOC) of a first high-voltage battery of a front mobility apparatus and an SOC of the second high-voltage battery.

According to at least one embodiment of the present disclosure, there is provided an add-on mobility apparatus configured to be driven by being connected to a front mobility apparatus including a plurality of first wheels, at least one first drive motor providing a driving force to the plurality of first wheels, a first high-voltage battery supplying power to the at least one first drive motor, and a first connection mechanism, the add-on mobility apparatus including a first left wheel and a first right wheel, at least one second drive motor configured to provide a driving force to the first left wheel and the first right wheel, a second high-voltage battery configured to supply driving power to the at least one second drive motor and charging power to the first high-voltage battery through a direct current (DC) to DC (DC/DC) converter, a second connection mechanism mechanically connected to the first connection mechanism, and a controller including a memory configured to store a computer program for controlling the at least one second drive motor and the second high-voltage battery and a processor configured to execute the computer program, wherein, by the execution of the computer program, the processor may be configured to determine the driving power and the charging power based on a first state of charge (SOC) of the first high-voltage battery and a second SOC of the second high-voltage battery.

In at least one embodiment of the present disclosure, the determining of the driving power and the charging power may include determining the driving power and the charging power such that the second SOC reaches a second minimum SOC while the first SOC reaches a first minimum SOC,.

In at least one embodiment of the present disclosure, the determining of the driving power and the charging power may include determining a driving factor for determining the driving power and a charging factor for determining the charging power, based on the first SOC and the second SOC.

In at least one embodiment of the present disclosure, the charging factor may be determined to be zero (0) when the first SOC is greater than the second SOC.

In at least one embodiment of the present disclosure, the driving factor may be determined based on a ratio of the second SOC to the first SOC.

In at least one embodiment of the present disclosure, the driving factor and the charging factor may each be determined to be a value greater than zero (0) when the first SOC is smaller than the second SOC.

In at least one embodiment of the present disclosure, the driving factor and the charging factor may be determined such that the second SOC matches the first SOC over time, when the first SOC is smaller than the second SOC.

In at least one embodiment of the present disclosure, the charging factor may be determined such that the first SOC is maintained until the second SOC matches the first SOC.

In at least one embodiment of the present disclosure, the processor may be configured to determine a second driving torque of the at least one second drive motor by multiplying a first driving torque of the at least one first drive motor by the driving factor.

In at least one embodiment of the present disclosure, the charging power may be determined by multiplying supply power of the at least one first drive motor by the charging factor.

According to at least one embodiment of the present disclosure, there is provided a method of controlling an add-on mobility apparatus configured to be driven by being connected to a front mobility apparatus including a plurality of first wheels, at least one first drive motor providing a driving force to the plurality of first wheels, a first high-voltage battery supplying power to the at least one first drive motor, and a first connection mechanism, wherein the add-on mobility apparatus may include a first left wheel and a first right wheel, at least one second drive motor configured to provide a driving force to the first left wheel and the first right wheel, a second high-voltage battery configured to supply driving power to the at least one second drive motor and charging power to the first high-voltage battery through a DC/DC converter, a second connection mechanism mechanically connected to the first connection mechanism; and a controller including a memory configured to store a computer program for controlling the at least one second drive motor and the second high-voltage battery and a processor configured to execute the computer program, the method including determining the driving power and the charging power based on a first SOC of the first high-voltage battery and a second SOC of the second high-voltage battery.

In a method of at least one embodiment of the present disclosure, the determining of the driving power and the charging power may include determining the driving power and the charging power such that the second SOC reaches a second minimum SOC while the first SOC reaches a first minimum SOC.

In a method of at least one embodiment of the present disclosure, the determining of the driving power and the charging power may include determining a driving factor for determining the driving power and a charging factor for determining the charging power, based on the first SOC and the second SOC.

In a method of at least one embodiment of the present disclosure, the charging factor may be determined to be zero (0) when the first SOC is greater than the second SOC.

In a method of at least one embodiment of the present disclosure, the driving factor may be determined based on a ratio of the second SOC to the first SOC.

In a method of at least one embodiment of the present disclosure, the driving factor and the charging factor may each be determined to be a value greater than zero (0) when the first SOC is smaller than the second SOC.

In a method of at least one embodiment of the present disclosure, the driving factor and the charging factor may be determined such that the second SOC matches the first SOC over time, when the first SOC is smaller than the second SOC.

In a method of at least one embodiment of the present disclosure, the charging factor may be determined such that the first SOC is maintained until the second SOC matches the first SOC.

In a method of at least one embodiment of the present disclosure, the processor may be configured to determine a second driving torque of the at least one second drive motor by multiplying a first driving torque of the at least one first drive motor by the driving factor.

In a method of at least one embodiment of the present disclosure, the charging power may be determined by multiplying supply power of the at least one first drive motor by the charging factor.

According to the embodiments of the present disclosure described herein, in driving of a front mobility apparatus and an add-on mobility apparatus driving by being connected to the front mobility apparatus, it is possible to prevent a decrease in efficiency (or fuel efficiency) of the front mobility apparatus.

In addition, it is also possible to reduce an energy path loss that may occur during charging and enable a strategy for consuming energy both in a first high-voltage battery of the front mobility apparatus and a second high-voltage battery of the add-on mobility apparatus.

### BRIEF DESCRIPTION OF THE FIGURES

FIG. 1 is a diagram illustrating a power system of a first mobility apparatus (e.g., an electric vehicle), which is a front mobility apparatus, according to an embodiment of the present disclosure.

FIG. 2 is a diagram illustrating a connection between a first mobility apparatus and a second mobility apparatus, which is an add-on mobility apparatus, according to an embodiment of the present disclosure.

FIG. 3 is a flowchart illustrating a control method according to an embodiment of the present disclosure.

FIG. 4 is a diagram illustrating a change in a state of charge (SOC) of a first high-voltage battery MB and a second high-voltage battery SB when a first SOC is greater than a second SOC, and a driving torque of a second drive motor (also referred to herein as “second driving torque”) and a charging power for charging the first high-voltage battery MB by the second high-voltage battery SB.

FIG. 5 is a diagram illustrating a change in SOC of a first high-voltage battery MB and a second high-voltage battery SB when a first SOC is smaller than a second SOC (at a time before t1), and a first driving torque, a second driving torque, and a charging power by the second high-voltage battery SB.

FIG. 6 is a diagram comparatively illustrating energy losses according to a comparative embodiment and an embodiment of the present disclosure.

### DETAILED DESCRIPTION

Hereinafter, embodiments of the present disclosure will be described in detail with reference to the accompanying drawings. The embodiments are not construed as limited to the disclosure and should be understood to include all changes, equivalents, and replacements within the idea and the technical scope of the disclosure.

The terms “module,” “unit,” and/or “-er/or” for referring to elements are assigned and used interchangeably in consideration of the convenience of description, and thus the terms per se do not necessarily have different meanings or functions. The terms “module,” “unit,” and/or “-er/or” do not necessarily require physical separation.

Although terms including ordinal numbers, such as “first,” “second,” and the like, may be used herein to describe various elements, the elements are not limited by these terms. These terms are only used to distinguish one element from another.

The term “and/or” is used to include any combination of multiple items that are subject to it. For example, “A and/or B” may include all three cases, for example, “A,” “B,” and “A and B.”

When an element is described as “coupled” or “connected” to another element, the clement may be directly coupled or connected to the other element. However, it is to be understood that another element may be present therebetween. In contrast, when an element is described as “directly coupled” or “directly connected” to another element, it is to be understood that there are no other elements therebetween.

The singular forms “a,” “an,” and “the” are intended to include the plural forms as well, unless the context clearly indicates otherwise. It is to be further understood that the terms “comprises/comprising” and/or “includes/including” used herein specify the presence of stated features, integers, steps, operations, elements, and/or components, but do not preclude the presence or addition of one or more other features, integers, steps, operations, elements, components and/or groups thereof.

Unless otherwise defined, all terms including technical and scientific terms used herein have the same meaning as commonly understood by one of ordinary skill in the art to which the present disclosure pertains. Terms, such as those defined in commonly used dictionaries, are to be interpreted as having a meaning that is consistent with their meaning in the context of the relevant art and the present disclosure, and are not to be interpreted in an idealized or overly formal sense unless expressly so defined herein.

In addition, the term “unit” or “control unit” is merely a widely used term for naming a controller that controls a specific vehicle function, and does not mean a generic functional unit. For example, each controller may include a communication device that communicates with another controller or a sensor to control a function assigned thereto, a memory that stores an operating system (OS), a logic command, input/output information, and the like, and one or more processors that perform determination, calculation, decision, and the like that are necessary for controlling a function assigned thereto.

Meanwhile, a processor may include a semiconductor integrated circuit and/or electronic devices that perform at least one or more of comparison, determination, computation, operations, and decision to achieve programmed functions. The processor may be, for example, any one or a combination of a computer, a microprocessor, a central processing unit (CPU), an application-specific integrated circuit (ASIC), and an electronic circuit (e.g., circuitry and logic circuits).

In addition, computer-readable recording media (or simply memory) include all types of storage devices that store data readable by a computer system. The storage devices may include at least one type of, for example, flash memory, hard disk, micro-type memory, card-type (e.g., secure digital (SD) card or extreme digital (XD) card) memory, random-access memory (RAM), static RAM (SRAM), read-only memory (ROM), programmable ROM (PROM), electrically erasable PROM (EEPROM), magnetic RAM (MRAM), magnetic disk, or optical disc.

This recording medium may be electrically connected to the processor, and the processor may load and record data from the recording medium. The recording medium and the processor may be integrated or may be physically separated.

Hereinafter, the accompanying drawings will be briefly described, and embodiments of the present disclosure will be described in detail with reference to the accompanying drawings.

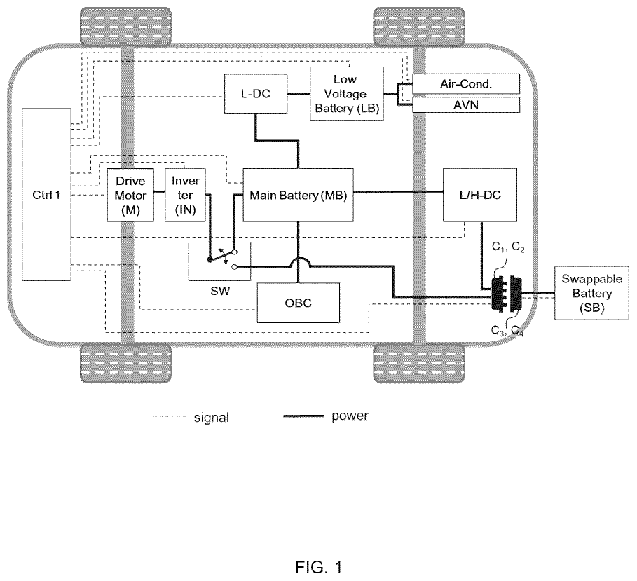

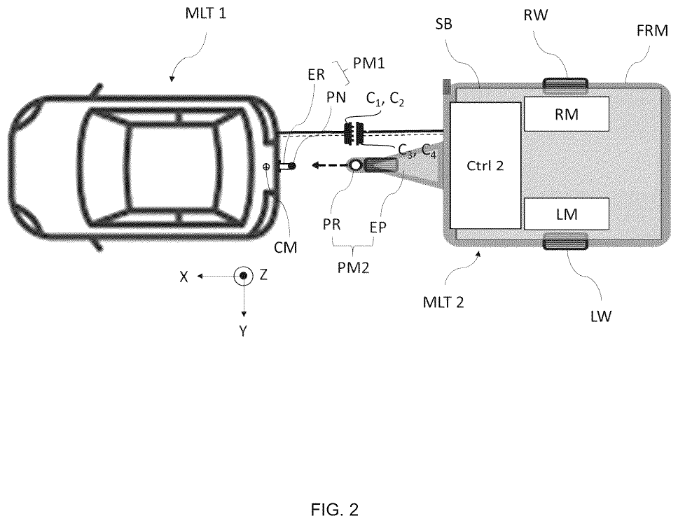

FIG. 1 is a diagram illustrating a power system of a first mobility apparatus MLT1 (e.g., an electric vehicle) according to an embodiment of the present disclosure, and FIG. 2 is a diagram illustrating a connection between a first mobility apparatus MLT1 and a second mobility apparatus MLT2 according to an embodiment of the present disclosure. The first mobility apparatus MLT1 may also be referred to herein as a front mobility apparatus, and the second mobility apparatus MLT2 may also be referred to herein as an add-on mobility apparatus.

Respective structures of the first mobility apparatus MLT1 and the second mobility apparatus MLT2 will be described in detail below with reference to FIGS. 1 and 2.

As shown in FIG. 1, the first mobility apparatus MLT1 may be, for example, an electric vehicle, and include a first drive motor M, an inverter IN, a first high-voltage battery (or a main battery, MB), an on-board charger (OBC), a first direct current (DC) to DC (DC/DC) converter L-DC, a low-voltage battery LB, an air-conditioning device Air-cond that operates with low voltage, an audio video navigation (AVN) system, a second DC/DC converter L/H-DC, a switch SW, and a controller (hereinafter referred to as a first controller).

The first drive motor M may provide a driving force to the wheels of the vehicle and may be, for example, an alternating current (AC) motor.

The inverter IN may convert DC power supplied to the first drive motor M into AC power.

The first high-voltage battery MB may be fixedly installed in the vehicle, for example, under the cabin floor.

The first high-voltage battery MB may supply electric power to the first drive motor M, as a main function, and may be charged by the OBC.

In addition, the first high-voltage battery MB may be connected to the low-voltage battery LB through the first DC/DC converter L-DC to charge the low-voltage battery LB.

To charge the low-voltage battery LB, the first DC/DC converter L-DC may be a step-down DC/DC converter (e.g., a low-voltage DC/DC converter LDC).

The low-voltage battery LB may be, for example, a 12 V or 24 V battery, and may supply electric power to electrical devices in the vehicle, such as, the air-conditioning device and the AVN system, which operate with low voltage.

A second high-voltage battery SB shown in FIG. 1 may be installed in the second mobility apparatus MLT2 to be described below.

The second high-voltage battery SB may be additionally, electrically, and separably connected to a power system of the vehicle including the first high-voltage battery MB, by a wired method (or a wireless method within a possible range), i.e., in a manner that the absence of the second high-voltage battery SB does not affect the operations (e.g., supplying power to electronic units, drive motor, or the like) of the power system.

The second high-voltage battery SB may also be referred to as a replaceable battery, an auxiliary battery, an extended battery, or a second or secondary battery, but this notation is provided only to differentiate it from the first high-voltage battery MB. That is, the functions, features, relationships with other objects (e.g., the first high-voltage battery MB, a host vehicle, etc.), mechanical/electrical/chemical structures, battery type (e.g., packaging, anode/cathode/separator material, etc.), charging type, and the like of the second high-voltage battery SB may not be limited by its notation or name.

The second high-voltage battery SB may be communicatively connected to a first controller Ctrl1 of the first mobility apparatus MLT1, which is a host vehicle, or a battery management system (BMS) of the first high-voltage battery MB, which will be described below, by wire or wirelessly. This may enable the transmission of various sensing information related to a state of charge (SOC) and physical/electrical/chemical states (e.g., voltage, current, temperature, etc.) of the second high-voltage battery SB to the first controller Ctrl1. However, examples are not necessarily limited thereto, and the information associated with the second high-voltage battery SB may also be transmitted to the first controller Ctrl1 through a second controller Ctrl2 of the second mobility apparatus MLT2, which will be described below.

In this embodiment, a high-voltage battery applied to the first high-voltage battery MB and the second high-voltage battery SB may include a plurality of battery cells (not shown) that output a unit voltage within, for example, 2.7 to 4.2 V. For example, a set number of battery cells may be connected in series/parallel to each other to form a single module. In addition, the high-voltage battery may be provided in a packaged form in which one or more battery modules are connected in series/parallel to each other to form a single battery package such that the high-voltage battery outputs a desired output voltage, for example, approximately 400 V, about 800 V, or several kV.

The high-voltage battery of the first high-voltage battery MB and the second high-voltage battery SB may include a BMS.

The BMS may include a battery management unit (BMU), a cell monitoring unit (CMU), and a battery junction box (BJB).

The BMS may perform a cell balancing function for ensuring the performance of the entire battery pack by maintaining the voltage of each cell constant, an SOC function for calculating the capacity of the entire battery system, and battery cooling, charging, and discharging control.

The BMU may receive information about all the cells from the CMU and perform the functions of the BMS based on the received information.

The BMU may include, for example, two microcontroller units (MCUs) each including one controller area network (CAN) communication port. It may also include a CAN interface to communicate with a vehicle controller, which may be an upper-level device of the BMS, and a CAN interface to collect information from the CMU, which is a lower-level device thereof.

The CMU may be directly attached to a battery cell to sense voltage, current, temperature, and the like. The CMU may simply perform sensing without performing calculations related to BMS algorithms. A plurality of battery cells may be connected to one CMU, and information of each cell may be transmitted to the BMU through the CAN interface.

The BJB may be a pack-level sensing mechanism of the BMS and a connection medium between the high-voltage battery and a drive system (e.g., a drivetrain). It may measure and record a battery voltage and a current flowing into and out of the battery to calculate an accurate SOC. The BJB may also perform safety-critical functions such as contactor and insulation monitoring, in addition to overcurrent detection.

The second high-voltage battery SB may be a high-voltage battery with a lower voltage than that of the first high-voltage battery MB and, in this case, the second DC/DC converter L/H-DC may be a step-up DC/DC converter. On the contrary, the second high-voltage battery SB may also be a high-voltage battery with a higher voltage than that of the first high-voltage battery MB and, in this case, the second DC/DC converter L/H-DC may be a step-down DC/DC converter.

In this embodiment, the second DC/DC converter L/H-DC may be included as a built-in in the first mobility apparatus MLT1 in the power system but is not limited thereto. For example, unlike this embodiment, the second DC/DC converter L/H-DC may be provided as a separate component and may be additionally and separably connected to the power system.

In this embodiment, for the separable electrical connection of the second high-voltage battery SB to the power system, the power system of the first mobility apparatus MLT1 may include first and second connectors C1 and C2, and the second high-voltage battery SB may include third and fourth connectors C3 and C4.

For example, the first and second connectors C1 and C2 may be one integrated connector, and the third and fourth connectors C3 and C4 may also be one integrated connector.

The first connector C1 may be connected to the second DC/DC converter L/H-DC, and the second connector C2 may be connected to the switch SW.

Although not shown, a signal transmission connector may also be added to transmit various sensing and state information of the second high-voltage battery SB to the controller.

The switch SW may be fixedly electrically connected to the inverter IN and may be switched on or off between the first high-voltage battery MB and the second connector C2 to electrically connect the inverter IN and the first high-voltage battery MB or electrically connect the inverter IN and the second high-voltage battery SB.

In this embodiment, the first controller Ctrl1 may be an uppermost-level vehicle controller that controls all the electric devices of the first mobility apparatus MLT1 but is not necessarily limited thereto. That is, for example, the first controller Ctrl1 shown FIG. 1 may be a power controller, which is a lower-level controller of the vehicle controller.

In addition, as described above, the first controller Ctrl1 may include a computer-readable recording medium that stores an operating system (OS), logic commands, input/output information, and the like, and at least one processor that reads what is stored in the recording medium to perform determinations, operations, decisions, selections, and the like required to control the functions.

In addition, although the first high-voltage battery MB is connected to the inverter IN through the switch SW, examples are not necessarily limited thereto. For example, the first high-voltage battery MB may also be connected directly to the inverter IN without the switch SW. In addition, in this case, the second connector and the fourth connector of the second high-voltage battery SB may not be required.

The second high-voltage battery SB shown in FIG. 1 may be installed in the second mobility apparatus MLT2 as shown in FIG. 2.

The second mobility apparatus MLT2 may include a frame FRM, a second left wheel LW installed on the left side of the frame FRM, a second right wheel RW installed on the right side of the frame FRM, a second left drive motor LM configured to provide a driving force to the second left wheel LW, a second right drive motor RM configured to provide a driving force to the second right wheel RW, and a second controller Ctrl2.

The second high-voltage battery SB may be fixedly installed in the second mobility apparatus MLT2 but is not necessarily limited thereto. That is, the second high-voltage battery SB may be removably installed in the second mobility apparatus MLT2. Thus, the second high-voltage battery SB that is mounted on the frame FRM and is fully discharged in its SOC state may be removed and replaced with a new second high-voltage battery SB that is fully charged in its SOC state.

When the second high-voltage battery SB is fixedly installed in the second mobility apparatus MLT2, the second mobility apparatus MLT2 may include a charging connector for charging the second high-voltage battery SB.

The frame FRM may form the exterior of the second mobility apparatus MLT2 and serve to accommodate therein other components.

The frame FRM may include a second pivot mechanism PM2 as a second connection mechanism, and the second pivot mechanism PM2 may be separably and pivotally connected to a first pivot mechanism PM1, which is a first connection mechanism fixed to a vehicle body of the first mobility apparatus MLT1.

For example, the first pivot mechanism PM1 may include an extension rod ER extending rearward from the vehicle body of the first mobility apparatus MLT1 and a pivot pin PN protruding upward from an end of the extension rod ER.

The second pivot mechanism PM2 may include a triangular extension portion EP protruding forward from the frame FRM of the second mobility apparatus MLT2 and a pivot ring PR into which the pivot pin PN is rotatably inserted from an end of the extension portion EP.

The pivot pin PN may be limited in its linear movement while inserted in the pivot ring PR and may only rotate about a Z-axis direction as shown in FIG. 2. Accordingly, while in the pivotally connected state, the second mobility apparatus MLT2 may be limited in its linear movement about a pivot connection point with respect to the first mobility apparatus MLT1 and may only rotate about a Z axis.

When driving in a forward direction, i.e., in an X-axis direction, the first mobility apparatus MLT1 and the second mobility apparatus MLT2 may maintain their linearity, without separate steering control for the second mobility apparatus MLT2,

In this embodiment, the first and second connection mechanisms may each include a pivot mechanism but are not necessarily limited thereto. For example, the first and second connection mechanisms may be known mechanisms that implement a non-rotational connection with respect to the Z axis.

The rotation axis of the second left drive motor LM may be connected to the second left wheel LW, through which the second left drive motor LM may provide a driving force to the second left wheel LW.

In addition, the rotation axis of the second right drive motor RM may be connected to the second right wheel RW, through which the second right drive motor RM may provide a driving force to the second right wheel RW.

Since the second left wheel LW and the second right wheel RW are respectively connected to the second left drive motor LM and the second right drive motor RM, they may be driven independently.

The second left drive motor LM and the second right drive motor RM may each be driven in the forward and reverse directions, and the second mobility apparatus MLT2 may travel forward when they are driven in the forward direction and travel backward when they are driven in the reverse direction.

For example, the second left drive motor LM and the second right drive motor RM may each be implemented as an in-wheel drive system in which a drive motor is installed within a wheel, but are not necessarily limited thereto.

In addition, unlike this embodiment, the left and right sides of the second mobility apparatus MLT2 are not driven independently, but the power of one common motor may be divided into the second left wheel LW and the second right wheel RW and the divided power may be transferred respectively. To this end, a common second drive motor and a differential gear may be included between the second left wheel LW and the second right wheel RW. That is, the power of the common second drive motor may be distributed by the differential gear and transferred to the second left wheel LW and the second right wheel RW.

As shown in FIG. 2, the second controller Ctrl2 may control the second left drive motor LM and the second right drive motor RM to enable forward and reverse travel of the second mobility apparatus MLT2. In addition, the second controller Ctrl2 may change a traveling direction of the second mobility apparatus MLT2 by controlling the torque or the number of revolutions of each of the second left drive motor LM and the second right drive motor RM. That is, controlling independently the driving of the second left drive motor LM and the second right drive motor RM may enable the steering of the second mobility apparatus MLT2 without a separate steering device.

In addition, a wired or wireless communication means may be included to transfer information between the connectors of FIG. 1 and the first mobility apparatus MLT1 and the second mobility apparatus MLT2, as described above.

In this embodiment, the first controller Ctrl1 or the second controller Ctrl2 may include a memory and a processor. The memory may store therein computer instructions for performing the functions of a corresponding controller, and the processor may perform the functions by loading the instructions from the memory and executing them.

The memory may include, as non-limiting examples, at least one of a hard disk drive (HDD), a solid-state drive (SDD), a silicon disk drive (SDD), a read-only memory (ROM), a random-access memory (RAM), a compact disc (CD)-ROM (CD-ROM), a magnetic tape, a floppy disk, and an optical data storage device.

In addition, the processor may include, as non-limiting examples, at least one of a computer, a microprocessor, a central processing unit (CPU), an application-specific integrated circuit (ASIC), an electric circuit, and a logic circuit.

As the first connector C1 and the second connector C2 of the first mobility apparatus MLT1 and the third connector C3 and the fourth connector C4 of the second mobility apparatus MLT2 are connected, and the signal transmission connector is connected, the first mobility apparatus MLT1 and the second mobility apparatus MLT2, i.e., the first controller Ctrl1 and the second controller Ctrl2, may become capable of communicating with each other.

When the first mobility apparatus MLT1 starts traveling forward while the first mobility apparatus MLT1 and the second mobility apparatus MLT2 are in mechanical and electrical connection, the second controller Ctrl2 may control the second left drive motor LM and the second right drive motor RM based on a signal transmitted from the first connector C1 based on the traveling speed to allow the second mobility apparatus MLT2 to travel forward straightly.

In this case, some or all of information including the speed, gear position, steering angle, accelerator pedal sensor (APS) information, and brake pedal sensor (BPS) information of the first mobility apparatus MLT1 may be transmitted to the second mobility apparatus MLT2.

For example, the second controller Ctrl2 of the second mobility apparatus MLT2 may use some or all of the information including the speed, gear position, APS information, and BPS information of the first mobility apparatus MLT1 to determine whether the first mobility apparatus MLT1 is in a forward traveling state or a reverse traveling state. However, examples are not limited thereto, and the second controller Ctrl2 of the second mobility apparatus MLT2 may receive information on whether the first mobility apparatus MLT1 is traveling forward or traveling in reverse directly from the first controller Ctrl1.

When the first mobility apparatus MLT1 is traveling forward, the second controller Ctrl2 may drive the second left drive motor LM and the second right drive motor RM in the forward direction such that the second mobility apparatus MLT2 travels forward straightly. In addition, when the first mobility apparatus MLT1 is traveling in reverse, the second controller Ctrl2 may drive the second left drive motor LM and the second right drive motor RM in the reverse direction such that the second mobility apparatus MLT2 travels in reverse.

In addition, the second controller Ctrl2 may determine a steering state based on the steering angle information of the first mobility apparatus MLT1 and perform the steering of the second mobility apparatus MLT2 accordingly.

The second mobility apparatus MLT2 may not include a separate steering device such as a steering wheel, a steering rack, and the like, but may still perform the steering by controlling the torque of the second left drive motor LM and the second right drive motor RM.

That is, the second controller Ctrl2 may calculate a driving torque for driving and a steering torque for steering for each of the second left drive motor LM and the second right drive motor RM and use them for control.

For example, to achieve the steering of the second mobility apparatus MLT2, the steering torque values of the second left drive motor LM and the second right drive motor RM according to the steering angle of the first mobility apparatus MLT1 may be included as a lookup table or calculation program.

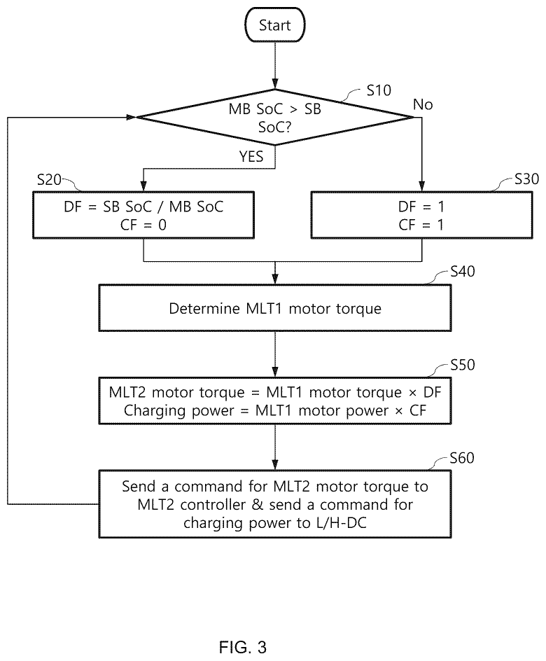

Hereinafter, a process of controlling the second mobility apparatus MLT2 will be described in detail with reference to FIG. 3.

First, in step S10, the processor of the second controller Ctrl2 may compare a first SOC of the first high-voltage battery MB and a second SOC of the second high-voltage battery SB.

In this case, the second controller Ctrl2 may receive the first SOC from the first controller Ctrl1, but examples are not necessarily limited thereto.

As described below, the second controller Ctrl2 may determine a driving factor DF to determine the driving power to be supplied to the second drive motor based on the first SOC and the second SOC, and may determine a charging factor CF to determine the charging power of the first high-voltage battery MB.

First, when it is determined that the first SOC is greater than the second SOC (Yes in S10), the second controller Ctrl2 may determine the driving factor DF and the charging factor CF accordingly.

In step S20, the second controller Ctrl2 may determine a ratio of the second SOC to the first SOC as the driving factor DF and determine zero (0) as the charging factor CF.

In step S30, when it is determined that the first SOC is less than the second SOC (No in S10), the second controller Ctrl2 may determine the driving factor DF and the charging factor CF to be 1, respectively.

Subsequently, the driving of the second drive motor and the charging of the first high-voltage battery MB may be controlled according to the driving factor DF and the charging factor CF determined in steps S20 and S30, which will be described in detail below.

First, in step S40, the second controller Ctrl2 may determine a driving torque (also referred to herein as a “first driving torque”) of the first drive motor M.

Subsequently, the second controller Ctrl2 may determine a driving torque (also referred to herein as a “second driving torque”) and the charging power of the second drive motor.

That is, the second driving torque may be determined by multiplying the first driving torque by the driving factor DF, and the charging power may be determined by multiplying the driving power of the first drive motor M by the charging factor CF, as in step S50.

In addition, the second controller Ctrl2 may control the second drive motor and the second DC/DC converter L/H-DC according to the second driving torque and the charging power determined in step S60.

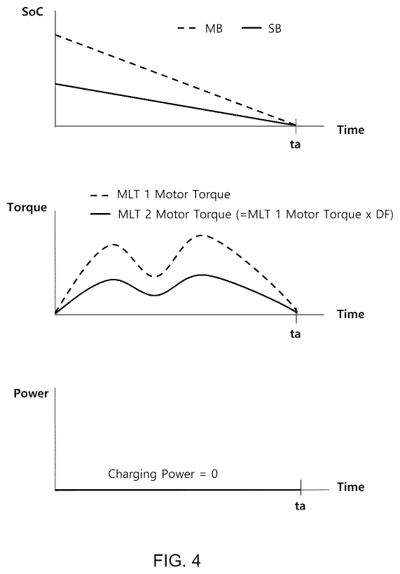

FIG. 4 is a diagram illustrating a change in an SOC of a first high-voltage battery MB and a second high-voltage battery SB when a first SOC is greater than a second SOC, and a driving torque of a second drive motor (also referred to herein as a “second driving torque”) and a charging power for charging the first high-voltage battery MB by a second high-voltage battery SB.

Referring to FIG. 4, the second driving torque may be determined by multiplying a first driving torque by a driving factor DF.

As shown in FIG. 4, since the charging power is zero (0), the power of the second high-voltage battery SB may be used only to generate the second driving torque.

As the second SOC approaches the first SOC as time elapses, the second SOC may be exhausted at a time ta when the first SOC is all exhausted.

That is, when the first SOC reaches a first minimum SOC of the first high-voltage battery MB, the second SOC may reach a second minimum SOC of the second high-voltage battery SB. In the embodiment of FIG. 4, the first minimum SOC and the second minimum SOC are the same, but are not necessarily limited thereto.

Referring to FIG. 4, a consistently certain level of driving assistance may be possible, and the load burden of the second mobility apparatus MLT2 that the first mobility apparatus MLT1 needs to bear may be reduced. Thus, a decrease in the (fuel) efficiency of the first mobility apparatus MLT1 may be prevented.

In addition, since charging is not performed in the case shown in FIG. 4, an energy path loss that may occur during the charging may be reduced, and a strategy for consuming all the energy of a battery may be enabled.

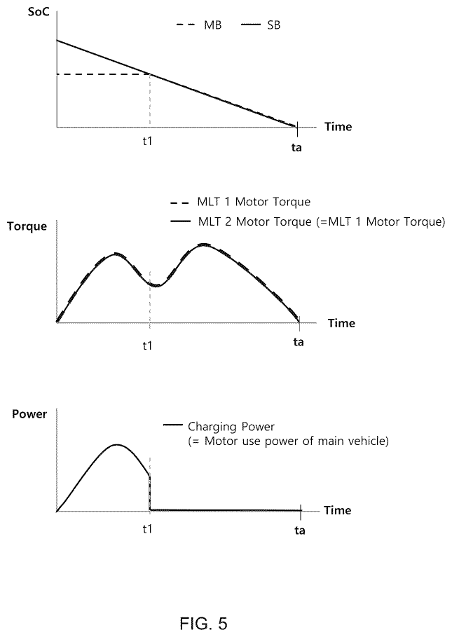

FIG. 5 is a diagram illustrating a change in an SOC of a first high-voltage battery MB and a second high-voltage battery SB when a first SOC is less than a second SOC (at a time before t1), and a first driving torque, a second driving torque, and a charging power by the second high-voltage battery SB.

First, in this case, the second high-voltage battery SB may be controlled such that the second SOC is equal to the first SOC at a time t1, and to this end, a driving factor DF and a charging factor CF may each be set to 1 in step S30.

Since the charging power is the same as the power used by the first drive motor M, the first high-voltage battery MB may be charged from the second high-voltage battery SB by the amount of power consumed for driving the first drive motor M and, accordingly, the first SOC may be maintained constant until the time t1.

Since the second high-voltage battery SB consumes the power for the second driving torque in addition to its charging power until the time t1, the second SOC may rapidly decrease and reach the first SOC at the time t1.

After the second SOC reaches the first SOC, i.e., after the time t1, the first SOC and the second SOC are the same, and thus the charging factor CF may become zero (0) and the charging of the first high-voltage battery MB by the second high-voltage battery SB may be stopped. That is, as shown in FIG. 5, the charging power may be supplied to the first high-voltage battery MB only up to the time t1 and may thereafter be zero (0).

In addition, as before the time t1, the driving factor DF may remain as 1 thereafter, and the second driving torque may be controlled to be the same as the second driving torque.

Also, in the case shown in FIG. 5, as time elapses after the time t1, the second SOC may be exhausted along with the first SOC.

In the case shown in FIG. 5, the use of energy of the first high-voltage battery and the use of energy of the second high-voltage battery may be controlled to the same level such that the energy of all the batteries may be consumed at the same time.

In addition, suspending or stopping the charging when both the batteries reach the same level may reduce the energy path loss during the charging, which may enable a strategy for efficiently using the energy of all the batteries.

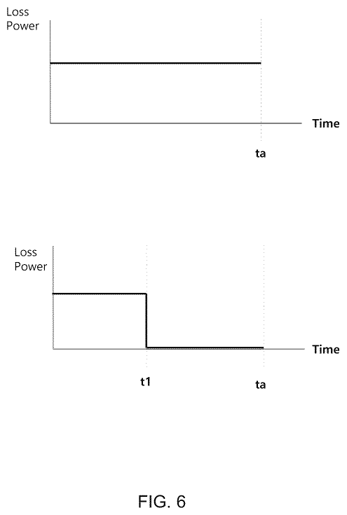

FIG. 6 is a diagram comparatively illustrating energy losses according to a comparative embodiment (in a case in which a second high-voltage battery is used only to charge a first high-voltage battery) and an embodiment described above with reference to FIG. 5.

As shown in FIG. 6, according to a comparative example (shown in upper portion), a power loss may continue to occur, but according to an example (shown in lower portion) of FIG. 5, a power loss due to an energy path may occur only up to a time t1, and from then on, the power loss may not occur.

Meanwhile, a required torque may be determined according to the driver's operation of an accelerator pedal in the first mobility apparatus MLT1, and may be determined such that a sum of a first driving torque and a second driving torque satisfies the required torque. For example, in step S40, the first driving torque may be determined according to the required torque and the driving factor.

While the disclosure has been described in connection with certain embodiments, it will be understood that it is not intended to limit the invention to those particular embodiments. On the contrary, it is intended to cover all alternatives modifications, and equivalents included within the spirit and scope of the disclosure as defined by the appended claims.

1. An add-on mobility apparatus configured to be driven by being connected to a front mobility apparatus comprising a plurality of first wheels, at least one first drive motor providing a driving force to the plurality of first wheels, a first high-voltage battery supplying power to the at least one first drive motor, and a first connection mechanism, the add-on mobility apparatus comprising:
a first left wheel and a first right wheel;
at least one second drive motor configured to provide a driving force to the first left wheel and the first right wheel;
a second high-voltage battery configured to supply driving power to the at least one second drive motor, and to supply charging power to the first high-voltage battery through a DC/DC converter;
a second connection mechanism mechanically connected to the first connection mechanism; and
a controller comprising a memory configured to store a computer program for controlling the at least one second drive motor and the second high-voltage battery and a processor configured to execute the computer program,
wherein, by the execution of the computer program, the processor is configured to:
determine the driving power and the charging power based on a first state of charge (SOC) of the first high-voltage battery and a second SOC of the second high-voltage battery.

2. The add-on mobility apparatus of claim 1, wherein determining the driving power and the charging power comprises:
determining the driving power and the charging power such that the second SOC reaches a second minimum SOC while the first SOC reaches a first minimum SOC.

3. The add-on mobility apparatus of claim 1, wherein determining the driving power and the charging power comprises:
determining a driving factor for determining the driving power and a charging factor for determining the charging power, based on the first SOC and the second SOC.

4. The add-on mobility apparatus of claim 3, wherein the charging factor is determined to be zero (0) in response that the first SOC being greater than the second SOC.

5. The add-on mobility apparatus of claim 3, wherein the driving factor is determined based on a ratio of the second SOC to the first SOC.

6. The add-on mobility apparatus of claim 3, wherein the driving factor and the charging factor are each determined to be a value greater than zero (0) when the first SOC is smaller than the second SOC.

7. The add-on mobility apparatus of claim 3, wherein the driving factor and the charging factor are determined such that the second SOC matches the first SOC over time, when the first SOC is smaller than the second SOC.

8. The add-on mobility apparatus of claim 7, wherein the charging factor is determined such that the first SOC is maintained until the second SOC matches the first SOC.

9. The add-on mobility apparatus of claim 3, wherein the processor is further configured to:
determine a second driving torque of the at least one second drive motor by multiplying a first driving torque of the at least one first drive motor by the driving factor.

10. The add-on mobility apparatus of claim 3, wherein the charging power is determined by multiplying supply power of the at least one first drive motor by the charging factor.

11. A method of controlling an add-on mobility apparatus configured to be driven by being connected to a front mobility apparatus comprising a plurality of first wheels, at least one first drive motor providing a driving force to the plurality of first wheels, a first high-voltage battery supplying power to the at least one first drive motor, and a first connection mechanism, wherein the add-on mobility apparatus comprises:
a first left wheel and a first right wheel;
at least one second drive motor configured to provide a driving force to the first left wheel and the first right wheel, a second high-voltage battery configured to supply driving power to the at least one second drive motor and charging power to the first high-voltage battery through a DC/DC converter, a second connection mechanism mechanically connected to the first connection mechanism, and a controller comprising a non-transitory memory configured to store computer-executable instructions for controlling the at least one second drive motor and the second high-voltage battery, and a processor configured to carry out the computer-executable instructions including operations comprising:
determining, the driving power and the charging power based on a first state of charge (SOC) of the first high-voltage battery and a second SOC of the second high-voltage battery.

12. The method of claim 11, wherein determining the driving power and the charging power comprises:
determining the driving power and the charging power such that the second SOC reaches a second minimum SOC while the first SOC reaches a first minimum SOC.

13. The method of claim 11, wherein determining the driving power and the charging power comprises:
determining a driving factor for determining the driving power, and a charging factor for determining the charging power, based on the first SOC and the second SOC.

14. The method of claim 13, wherein the charging factor is determined to be zero (0) when the first SOC is greater than the second SOC.

15. The method of claim 13, wherein the driving factor is determined based on a ratio of the second SOC to the first SOC.

16. The method of claim 13, wherein the driving factor and the charging factor are each determined to be a value greater than zero (0) when the first SOC is smaller than the second SOC.

17. The method of claim 13, wherein the driving factor and the charging factor are determined such that the second SOC matches the first SOC over time, when the first SOC is smaller than the second SOC.

18. The method of claim 17, wherein the charging factor is determined such that the first SOC is maintained until the second SOC matches the first SOC.

19. The method of claim 13, wherein the operations further include:
determining a second driving torque of the at least one second drive motor by multiplying a first driving torque of the at least one first drive motor by the driving factor.

20. The method of claim 13, wherein the charging power is determined by multiplying supply power of the at least one first drive motor by the charging factor.
